(19) United States
(12) Patent Application Publication
(10) Pub. No.: US 2026/0146592 A1
(43) Pub. Date: May 28, 2026

(54) SYSTEM AND METHOD FOR GENERATING ENERGY

(71) Applicant: RONALD FORHAN, Bel Air, MD (US)

(72) Inventor: RONALD FORHAN, Bel Air, MD (US)

(21) Appl. No.: 19/398,873

(22) Filed: Nov. 24, 2025

Related U.S. Application Data
(60) Provisional application No. 63/724,370, filed on Nov. 24, 2024.

(51) Int. Cl. F03G 7/10; F03G 7/00; F03G 7/04

(52) U.S. Cl. CPC F03G 7/129; F03G 7/0252; F03G 7/04; F03G 7/104; F05B 2260/208

(57) ABSTRACT

A system for generating rotational force(s) includes a body having a primary chamber and a plurality of extension members having a plurality of secondary chambers. Each extension member of the plurality of extension members includes at least one secondary chamber in fluid communication with the primary chamber. A system for generating energy includes a generator having a body with a primary chamber and a plurality of extension members connected to the body. Each extension member may define at least one secondary chamber in fluid communication with the primary chamber. The generator is rotatably connected to a shaft, and the shaft is rotatably connected to a motor and is configured to transfer a rotational force of the generator to the motor.

### CROSS REFERENCE TO RELATED APPLICATION

This application claims priority benefit under 35 U.S.C. § 119 of U.S. Provisional Application No. 63/724,370, filed Nov. 24, 2024, and entitled, ENERGY GENERATION DEVICE UTILIZING ROTATIONAL DYNAMICS, PHASE-CHANGE PRINCIPLES, AND GRAVITY, which is incorporated herein by reference in its entirety.

### TECHNICAL FIELD

The present disclosure relates generally to devices used to harness and/or generate energy. Specifically, the present disclosure relates to devices which utilize gravity to harness and/or generate energy.

### BACKGROUND

Conventional energy generation technologies rely heavily on finite or environmentally impactful resources, despite growing concerns regarding environmental degradation and resource depletion. While renewable energies have made significant progress, they remain subject challenges such as significant material or special requirements, or high maintenance costs, among other challenges.

Gravity-based energy systems and devices provide a predictable and environmentally friendly route for generating energy, as gravity is a constant and readily available natural force. Unlike systems that rely on fuels or specific environmental conditions, gravity-based systems may operate for long periods of time with minimal external inputs after an initial startup input. However, many gravity-based implementations are mechanically complex, come with high construction or maintenance costs, or are limited in their adaptability for widespread use.

Accordingly, there remains a need for improved gravity-based energy generation devices, systems and/or methods that can efficiently convert heat and/or gravitational forces into usable energy while overcoming the limitations of prior art systems.

### SUMMARY

The present disclosure is directed toward devices, apparatus, systems and methods for efficiently generating energy.

The present disclosure provides, in a first aspect, a system for generating rotational force(s) including a body having a primary chamber and a plurality of extension members having a plurality of secondary chambers. Each extension member of the plurality of extension members includes at least one secondary chamber in fluid communication with the primary chamber.

The present disclosure provides, in a second aspect, a system for generating energy including a generator having a body with a primary chamber and a plurality of extension members connected to the body. Each extension member of the plurality of extension members defines at least one secondary chamber in fluid communication with the primary chamber. The generator is rotatably connected to a shaft, and the shaft is rotatably connected to a motor and configured to transfer a rotational force of the generator to the motor.

The present disclosure provides, in a third aspect, a method of generating electricity including creating a pressure differential between a primary chamber of a body of a generator containing a liquid and at least one secondary chamber of an extension member of the generator, wherein the at least one secondary chamber is in fluid communication with the primary chamber. The method further includes at least partially rotating the generator about a center axis extending from a center of a top of the body through a center of the bottom of the body, wherein the at least partially rotating is caused by the creating a pressure differential. The method further includes transferring a force of a rotational movement of the generator to a motor and/or an energy storage device.

These and other objects, features, and advantages of this disclosure will become apparent from the following detailed description of the various aspects of the disclosure taken in conjunction with the accompanying drawings.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1 depicts a first perspective view of an energy generation device, in accordance with an aspect of the present disclosure;

FIG. 2 depicts a second perspective view of the energy generation device of FIG. 1, in accordance with an aspect of the present disclosure;

FIG. 3 depicts a top view of the energy generation device of FIG. 1, in accordance with an aspect of the present disclosure;

FIG. 4 depicts a bottom view of the energy generation device of FIG. 1, in accordance with an aspect of the present disclosure;

FIG. 5 depicts a first side view of the energy generation device of FIG. 1, in accordance with an aspect of the present disclosure;

FIG. 6 depicts a second side view of the energy generation device of FIG. 1, in accordance with an aspect of the present disclosure;

FIG. 7 depicts a first cross-sectional view of the energy generation device of FIG. 1 taken along line 7-7 of FIG. 5, in accordance with an aspect of the present disclosure;

FIG. 8 depicts a second cross-sectional view of the energy generation device of FIG. 1 taken along line 8-8 of FIG. 6, in accordance with an aspect of the present disclosure;

FIG. 9 depicts a third cross-sectional view of the energy generation device of FIG. 1 taken along line 9-9 of FIG. 3, in accordance with an aspect of the present disclosure;

FIG. 10 depicts a fourth cross sectional view of the energy generation device of FIG. 1 taken along line 10-10 of FIG. 6, in accordance with an aspect of the present disclosure;

FIG. 11 depicts a wire-frame perspective view of the energy generation device of FIG. 1 in an operational position and filled with a fluid, in accordance with an aspect of the present disclosure;

FIG. 12 depicts a first perspective view of a system of the present disclosure utilizing the energy generation device of FIG. 1, in accordance with an aspect of the present disclosure;

FIG. 13 depicts a side view of the system of FIG. 12, in accordance with an aspect of the present disclosure;

FIG. 14 depicts a cross-sectional side view of the system of FIG. 12 taken along line 14-14 of FIG. 12, in accordance with an aspect of the present disclosure;

FIG. 15 depicts a series of partial perspective views of the system of FIG. 12 illustrating one or more rotational movement(s) of a portion of the system of FIG. 12 that includes the energy generation device of FIG. 1, in accordance with an aspect of the present disclosure;

FIG. 16 depicts perspective view of one or more rotational movement(s) of a portion of an alternative embodiment of the system of FIG. 12, in accordance with an aspect of the present disclosure;

FIG. 17 depicts a front perspective view of another alternative embodiment of the system of FIG. 12 which uses a first thermoelectric heat pump, in accordance with an aspect of the present disclosure;

FIG. 18a depicts a cross-sectional view of a portion of the system of FIG. 17 taken along line 18-18 of FIG. 17 that includes the first thermoelectric pump, in accordance with an aspect of the present disclosure;

FIG. 18b depicts a close up view of a portion of FIG. 18a, in accordance with an aspect of the present disclosure;

FIG. 19 depicts a front perspective view of yet another alternative embodiment of the system of FIG. 12 which uses a second thermoelectric heat pump, in accordance with an aspect of the present disclosure;

FIG. 20 depicts a side view of the system of FIG. 19, in accordance with an aspect of the present disclosure;

FIG. 21 depicts a front perspective view of yet another alternative embodiment of the system of FIG. 12 that uses a third thermoelectric heat pump, in accordance with an aspect of the present disclosure;

FIG. 22 depicts a side view of the system of FIG. 21, in accordance with an aspect of the present disclosure;

FIG. 23 depicts a side view of yet another alternative embodiment of the system of FIG. 12 that includes a motor and a battery mounted on a top of a shaft, in accordance with an aspect of the present disclosure; and

FIG. 24 depicts a perspective view of an alternative embodiment of the energy generation device of FIG. 1 which includes a surface enhancing structure and one or more fins, in accordance with an aspect of the present disclosure.

### DETAILED DESCRIPTION

Generally stated, disclosed herein are devices, apparatus, and systems for efficiently generating energy. Further, methods for using the devices, apparatus, and systems for efficiently generating energy are discussed.

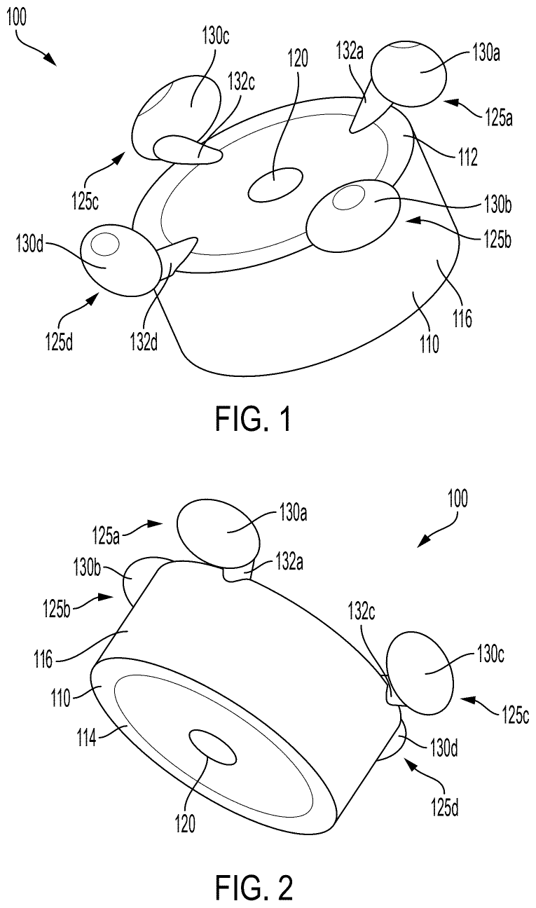

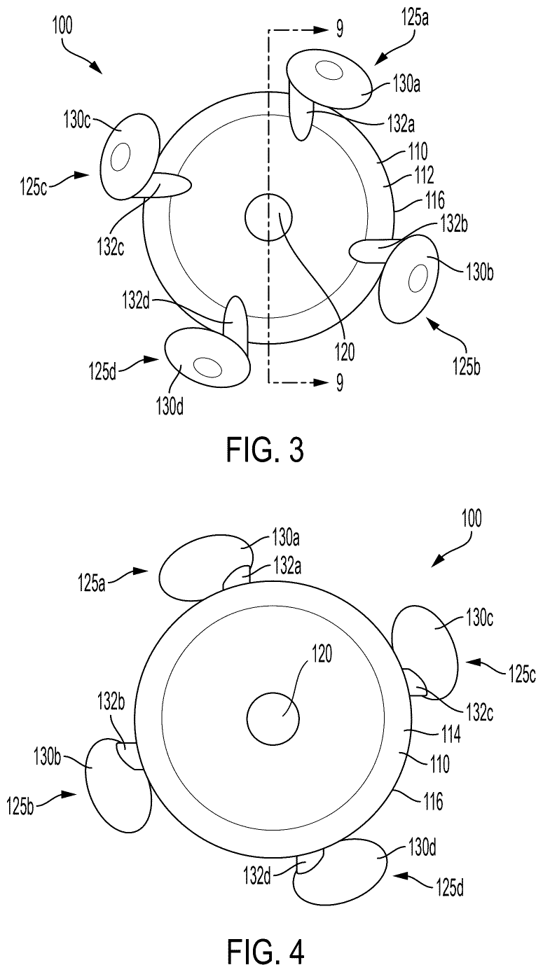

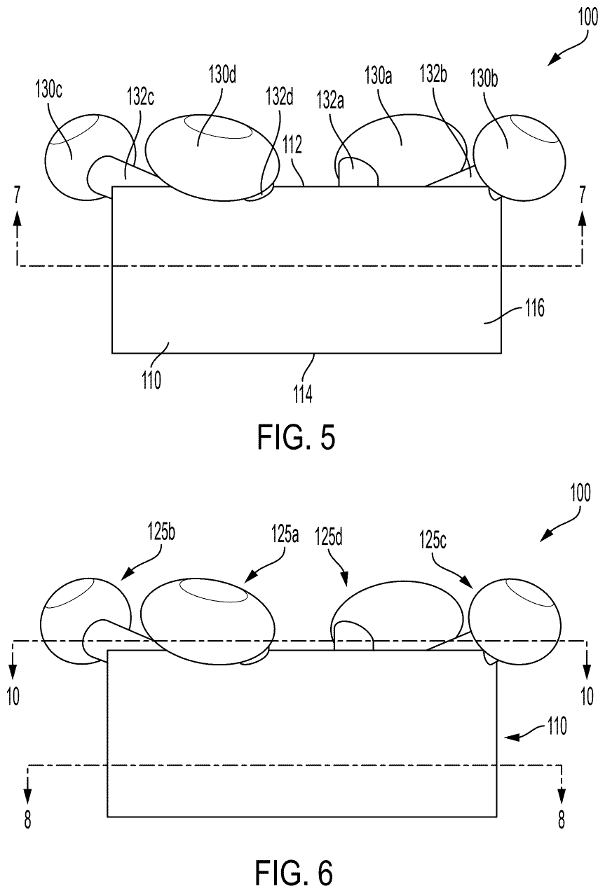

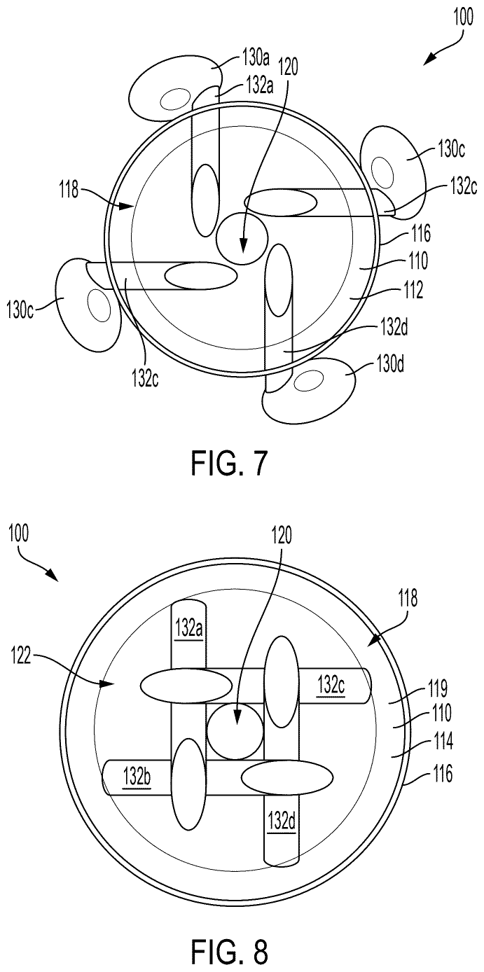

Referring to the drawings, wherein like reference numerals are used to indicate like or analogous components throughout the several views, and with particular reference to FIGS. 1-23, apparatus, devices, systems, and methods of using the apparatus, devices, and systems for efficiently generating energy are shown and described.

Referring to FIGS. 1-10, an embodiment of a generator and/or energy generation device and/or system for generating energy (e.g., mechanical energy, electrical energy) according to aspects disclosed herein will be described in detail. In an embodiment, the energy generation device 100 may include a body 110 connected to a plurality of extension members 125. In the example shown in FIG. 1, the body 110 may include a top 112, a bottom 114, and a side 116 extending between the top 112 and the bottom 114. In some embodiments, the body 110 may be substantially cylindrical, however, other shapes may also work for the body 110 so long as the chosen shape does not interfere with the ability of the energy generation device 100 to rotate as described below. For example, in some embodiments (not shown) the body 110 may be spherical. In other embodiments (not shown), the body may be a polygonal shape so long as measures are taken to ensure the energy generation device 100 is at least substantially balanced around a longitudinal axis 102 extending through a center of the body 110, as explained in more detail below.

The top 112 and the bottom 114 may be connected to and/or by the side 116 and may further define and/or bound a primary chamber 118 (e.g., an interior space of the body 110). The top 112 and the bottom 114 are shown as being substantially flat and smooth, but in other embodiments the top 112 and/or the bottom 114 may not be flat and/or smooth. Similarly, the side 116 is shown as being a smooth, evenly rounded, continuous surface, but in other embodiments the side 116 may not be smooth, evenly rounded, and/or continuous. As explained below, in some embodiments it may be beneficial to heat the body, for example, using solar energy. In such embodiments, the top 112, the bottom 114, and/or the side 116 may include nodes or bumps (not shown) configured (e.g., sized, shaped and/or dimensioned) to increase a surface area of an exterior surface of the body 110 (e.g., exterior surfaces of the top 112, the bottom 114 and/or the side 116). Such an increased surface area may result in the body 110 receiving more thermal energy and/or heat (e.g., generally and/or with respect to any or all of the plurality of extension members 125).

In some embodiments, the body 110 may optionally include a through-hole 120 for mounting the energy generation device 100, as described in more detail below. In other embodiments, the body 110 may lack the through-hole 120 and may instead feature a partial hole or a cavity. In even further embodiments, the body 110 may be formed integrally with a means for mounting the energy generation device 100.

As shown in FIGS. 1-10, the energy generation device 100 may include plurality of extension members 125 rigidly or semi-rigidly connected to the body 110. The plurality of extension members 125 may include a first extension member 125a, a second extension member 125b, a third extension member 125c, and a fourth extension member 125d. Each extension member of the plurality of extension members 125 may be connected to the body 110 and may further include at least one bulb and/or head 130 and at least one arm and/or stem 132. For example, the first extension member 125a may include at least a first head 130a and at least a first stem 132a extending from the first head 130a; the second extension member 125b may include at least a second head 130b and at least a second stem 132b extending from the second head 130b; the third extension member 125c may include at least a third head 130c and at least a third stem 132c extending from the third head 130c; and the fourth extension member 125d may include at least a fourth head 130d and at least a fourth stem 132d extending from the fourth head 130d. In other embodiments, there may be more or less than four extension members, but for illustrative purposes the embodiment described herein features the plurality of extension members 125 (e.g., 125a, 125b, 125c, and 125d) as just described. However, regardless of the total number of extension members 125, it may be important that the extension members 125 be at least substantially balanced about and/or with respect to the body 110 to facilitate the functioning of the energy generation device 100, as described in more detail below.

The heads 130 of the plurality of extension members 125 may each define and/or bound one or more secondary chamber(s) 131. For example, as shown in FIG. 10, the first head 130a may bound a first secondary chamber 131a; the second head 130b may bound a second secondary chamber 131b; the third head 130c may bound a third secondary chamber 131c; and the fourth head 130d may bound a fourth secondary chamber 131d. Each of the one or more secondary chamber(s) may be in fluid communication with the primary chamber 118. In the example, the heads 130 are shown having a spheroid shape. However, in other embodiments, the heads 130 may have different shapes, such as a spherical or polygonal shape, so long as the energy generation device 100 is substantially balanced about the longitudinal axis 102, as further explained below.

Each of the stems 132 of the plurality of extension members 125 may be tubular and/or hollow such that the stems 132 may facilitate fluid communication between the primary chamber 118 and each of the respective secondary chambers 131. For example, the first stem 132a may facilitate fluid communication between the first secondary chamber 131a and the primary chamber 118; the second stem 132b may facilitate fluid communication between the second secondary chamber 131b and the primary chamber 118; the third stem 132c may facilitate fluid communication between the third secondary chamber 131c and the primary chamber 118; and the fourth stem 132d may facilitate fluid communication between the fourth secondary chamber 131d and the primary chamber 118. Further, an interior space of the energy generation device 100, which may include and/or be defined by at least the primary chamber 118 and the secondary chambers 131, as well as the hollow portions of the stems 132 as just described, may be vacuum sealed from an external environment (e.g., outside of the energy generation device 100). In such an embodiment, at least a portion of the vacuum sealed interior of the energy generation device 100 may include a fluid 180, as described in more detail below.

In some embodiments, the fluid 180 may need to be injected, inserted, included, and/or otherwise added into at least the primary chamber 118 during the manufacturing process. In other embodiments, the energy generation device 100 may include a fluid injection port or similar (not shown) configured (e.g., sized, shaped, and/or dimensioned) to allow for fluid to be added or removed from the energy generation device 100, as needed. In some embodiments, the fluid 180 may be acetone. In other embodiments the fluid 180 may be dichloromethane (DCM or methylene chloride), trichlorofluoromethane, ether, alcohol, carbon tetrachloride, and/or chloroform. In further embodiments, the fluid 180 may be some mix of substances, such as those just listed. Preferably, the substance chosen for the fluid 180 has a low evaporation point, as a more readily evaporative substance may more efficiently be used to create pressure differentials which drive rotational movement(s) of the energy generation device 100. Notably, the fluid 180 may change forms during operation of the system as described below, such as changing from a liquid to a gas or vapor, and/or from a gas or vapor to a liquid. Thus, references to the fluid 180 throughout this detailed description may refer to the fluid 180 in liquid form, vapor/gaseous form, or both.

The type of substance(s) chosen for the fluid 180 may influence the materials making up the energy generation device 100. For example, materials used for the energy generation device 100 may be selected based on having non-reactive qualities with respect to interactions with any substance(s) used as the fluid 180. In an embodiment in which acetone is used as the fluid 180, the energy generation device 100 (e.g., the body 110 and the plurality of extension members 125) may be made of glass or a metal which does not react with acetone and/or sunlight (e.g., aluminum), or which is only minimally reactive with acetone and/or sunlight. In other embodiments, the energy generation device 100 may be made of some other material, such as a plastic (e.g., polytetrafluoroethylene). In some embodiments, the body 110 of the energy generation device 100 may be formed of a different material than are the extension members 125 or portions thereof (e.g., the heads 130 and/or the stems 132), which may drive differences in heat conductivity between the body 110 as compared to any or all extension members 125, which may increase the efficiency of the energy generation device 100 during operation.

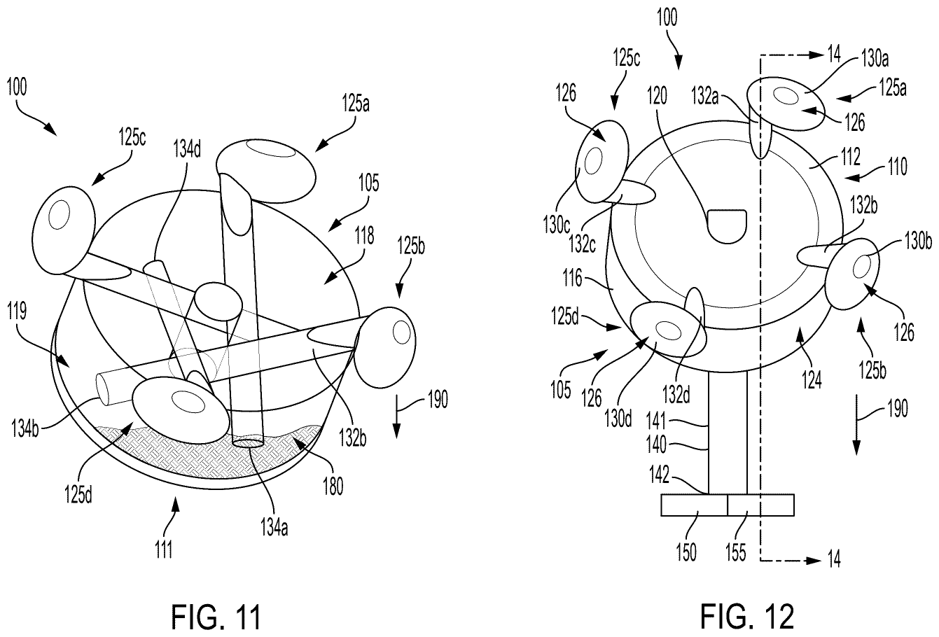

To facilitate fluid communication between the primary chamber 118 and each of the secondary chambers 131, each of the stems 132 may include at least a primary opening 134 and a secondary opening 136, as shown in FIGS. 10-11. For example, the first stem 132a may include a first primary opening 134a in the primary chamber 118 and a first secondary opening 136a in the first secondary chamber 131a; the second stem 132b may include a second primary opening 134b in the primary chamber 118 and a second secondary opening 136b in the second secondary chamber 131b; the third stem 132c may include a third primary opening 134c (position obscured by stem 132b) in the primary chamber 118 and a third secondary opening 136c in the third secondary chamber 131c; and the fourth stem 132d may include a fourth primary opening 134d and a fourth secondary opening 136d in the fourth secondary chamber 131d.

In some embodiments, the heads 130 of the extension members 125 may be connected to the body 110 via the stems 132, as shown in FIGS. 1-11. For example, at least a portion of the first stem 132a may extend from the body 110 to the first head 130a; at least a portion of the second stem 132a may extend from the body 110 to the second head 130b; at least a portion of the third stem 132c may extend from the body 110 to the third head 130c; and at least a portion of the fourth stem 132d may extend from the body 110 to the fourth head 130d. In different embodiments, the stems 132 may be of different lengths than shown in FIGS. 1-10, but generally each stem 132 may be substantially equal in length and/or position with respect to the body 110 to substantially equally distribute the weight of the extension members 125 (e.g., radially) about the body as further described below.

The connection of the stems 132 to the heads 130 may be biased and/or offset, such that a weight of each of the heads 130 may be unbalanced with respect to each of the respective stems 132 to which they are attached. In the embodiment shown, each of the heads 130 may be offset to the same degree or a substantially similar degree as each other such that the extension members 125 remain at least substantially radially balanced and/or symmetrical with respect to each other about a longitudinal axis 102 extending through a longitudinal center of the body 10 and/or the through-hole 120, despite each of the extension members 125 having offset components (e.g., heads 130 offset from stems 132). This offsetting may be important in some embodiments to drive rotational movement(s) and/or force(s) of the energy generation device as described in more detail below.

In the example, portions of the stems 132 are shown extending outwardly from or partially from an edge of the body 110 at which the top 112 and the side 116 are joined. However, in other embodiments, the stems 132 may extend outwardly from other locations on and/or around the body 110. For example, the stems 132 may extend entirely from a location on the top 112 or entirely from a location on the side 116 of the body 110. Regardless of where the stems 132 extend from the body 110, it may be important that the extension members 125 remain at least substantially radially balanced about the body 110 and/or the longitudinal axis 102.

In further embodiments, each of the heads 130 of the plurality of extension members 125 may be fused and/or made integral with the body 110 (not shown), such that the heads 130 are directly connected to the body 110 as opposed to being connected to the body 110 via one or more of the stems 132. In such embodiments, each of the stems 132 may extend from each of the respective secondary chambers 131 (e.g., from an interior-facing portion of each of the heads 130) into the primary chamber 118, such that each of the secondary chambers 131 are in fluid communication with the primary chamber 118. However, such an arrangement in which the stems 132 do not extend outside of the body 110 to create separation between the heads 130 and the body 110 may be less preferable, as stems 132 which extend outwardly from the body may result in more leverage, allowing the energy generation device 100 to more efficiently generate mechanical energy (which may be converted to electrical energy) from heat by using gravitational force(s) and/or rotational movement(s), as described in more detail below.

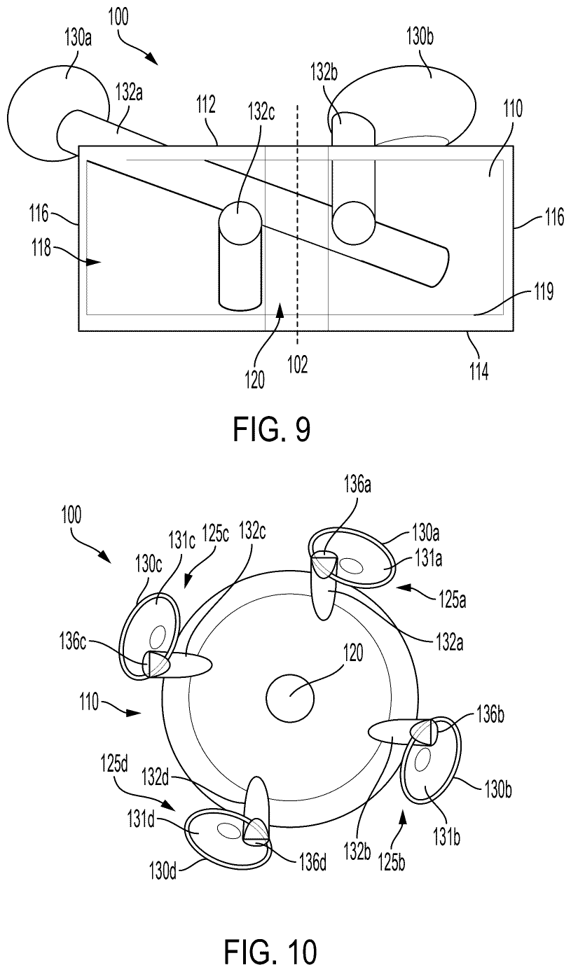

In the embodiment shown in FIGS. 1-11, the plurality of extension members 125 are identical or substantially identical and are arranged radially and symmetrically about a center of the body 110 and/or the through-hole 120. More specifically, and depending on the embodiment, the plurality of extension members 125 are arranged on the body 110 radially and symmetrically about the longitudinal axis 102 (e.g., FIG. 9) of the body 110 and/or the through-hole 120. In the embodiment shown, the plurality of extension members 125 are arranged about the longitudinal axis 102 of at least the through-hole 120, but in embodiments which lack the through-hole, it may be said that the plurality of extension members 125 are arranged at least about the longitudinal axis 102 of the body 110. The benefit of this arrangement of the extension members 125 around the body 110 is that the extension members 125 are radially balanced (or substantially radially balanced) about the body 110 (e.g., when the bottom 114 of the body 110 is laying flat and/or parallel on a horizontal surface), which may be advantageous for maintaining and/or driving the rotational movement(s) and/or force(s) of the energy generation device 100 (or other embodiments thereof), as described in more detail below. In some embodiments of the system which include a shaft (as also described below), the longitudinal axis 102 may be aligned with and/or extend through a longitudinal center of the shaft.

In some embodiments, the plurality of extension members 125 may not be identical and/or may not be arranged symmetrically at all, and instead may be configured (e.g., sized, shaped and/or dimensioned) so as to be balanced about the longitudinal axis 102 of the body 110 (e.g., when the bottom 114 is laying flat and/or parallel on a horizontal surface) without having identical shapes and/or positions with respect to each other.

Turning to FIG. 11, the energy generation device 100 is shown in an operational configuration and/or position 105. Specifically, the energy generation device 100 is shown angled with respect to a direction of gravity 190 and containing a fluid 180 in at least the primary chamber 118. In the embodiment shown, the fluid 180 may be a liquid at room temperature. Due to the angle of the energy generation device 100 in the operational position 105, the fluid 180 (e.g., in liquid form) may pool in a bottom-most portion 111 of the primary chamber 118, such that the fluid 180 may submerge at least one of the primary openings 134, but not all of the primary openings 134.

In some embodiments, the fluid 180 may be acetone. In other embodiments different substances may be used as the fluid 180, such as dichloromethane (DCM or methylene chloride), trichlorofluoromethane, ether, alcohol, carbon tetrachloride and/or chloroform. In further embodiments, even water may be used as the fluid 180, for example, where the energy generation device 100 is used in high temperature applications, such that it may be desirable to use a substance having a relatively high evaporation point and/or temperature (e.g., compared to substances like acetone) to better control the phase-changes of the fluid 180 that are leveraged to create rotational movements of the energy generation device 100, as explained further below. Similarly, for application(s) of aspect described herein in relatively cold environments (e.g., arctic environments), a substance may be chosen for the fluid 180 that has a relatively low evaporation point and/or temperature (e.g., compared to substances like acetone). However, under more typical environmental conditions, it may be preferable to select substances to use for the fluid 180 that have low evaporation points and/or temperatures, as such substances may readily evaporate at typical ambient temperatures and thus may be efficient at driving the desired pressure differentials necessary for the energy generation device 100 to turn and/or rotate during operation, as described in more detail below.

The amount and/or volume of the fluid 180 present in the energy generation device 100 may be dependent on various factors. For example, as the size of the energy generation device 100 and/or any of its components is/are scaled up, more of the fluid 180 may need to be present in the primary chamber 118 for the energy generation device 100 to be functional. Other factors may include, without limitation, the evaporation speed or temperature of a substance chosen for the fluid 180, an angle at which any of the stems 132 extend into the primary chamber 118, the length of any of the stems 132 relative to a distance between the top 112 and the bottom 114 of the body, among other factors. However, the single most important principle influencing the amount of the fluid 180 that may be utilized in the energy generation device 100 during operation is that the fluid volume and/or level must be high enough that, as the energy generation device 100 rotates about the longitudinal axis 102 (e.g., FIG. 9), at least one of the primary openings 134 (e.g., the first primary opening 134a)—but not all of the primary openings 134—may be fully submerged below a surface level of the fluid 180 (e.g., in liquid form) to prevent the exchange of gas(es) and/or vapor between the primary chamber 118 and at least one secondary chamber 131, which may create a suction effect. The suction effect may allow for at least a portion of the fluid 180 to be pushed and/or drawn up from the primary chamber 118 towards and/or into at least one of the secondary chambers 131 as the result of temperature and/or pressure changes within the energy generation device 100.

Thus, in some embodiments, the operational position and/or configuration 105 may be defined at least in part as a position and/or configuration which allows for at least one of the primary openings 134 to be submerged in the fluid 180 (e.g., in liquid form) within the primary chamber 118, while at least one different primary opening is simultaneously at least partially outside of any liquid portion(s) of the fluid 180. For example, when the energy generation device 100 is in the operational position 105 as in FIGS. 11-14, the first primary opening 134a may be submerged in the fluid 180 (e.g., below a surface level of the fluid 180 in liquid form), and the second primary opening 134b, the third primary opening 134c, and/or the fourth primary opening 134d may be at least partially outside and/or above the surface level of the fluid. Where the bottom 114 of the body 110 of the energy generation device 100 is lying flat on a horizontal surface, and depending on the amount and/or volume of the fluid 180 (e.g., in liquid form) present in the energy generation device 100, it may not be possible for at least one of the primary openings 134, but not all of the primary openings 134, to be submerged below a surface level of the fluid 180 (e.g., in liquid form), and thus, in such situations the energy generation device 100 may not be said to be in the operational position and/or configuration 105. For example, when the bottom 114 of the body 110 of the energy generation device 100 is lying flat on a horizontal surface, all of the primary openings 134 may be submerged below the surface level of the fluid 180 (e.g., in fluid form), or all of the primary openings 134 may be at least partially outside of any liquid portion(s) of the fluid 180.

Turning now to FIGS. 12-15, a system and associated process for generating energy using aspects of the present disclosure will be described in detail. The system may operate by using thermal energy from environmental and/or supplied sources to drive phase-change dynamics, converting the thermal energy to mechanical energy that may then be harnessed as electricity. For illustrative purposes, a first embodiment of the system is described with reference to use of the energy generation device 100. However, it should be understood by one of ordinary skill that various embodiments of the energy generation device(s) disclosed herein may be used with and/or in the system (e.g., embodiments of the energy generation device 100 which utilize different aspects, features, components and/or configurations as disclosed herein).

As shown in FIGS. 12-15, a system and process for generating energy according to aspects disclosed herein may include the energy generation device 100 (e.g., in the operational position 105), the fluid 180 (e.g., inside the energy generation device 100), a foundation 150 (e.g., a motor), and a rod, shaft or other means 140 of rotatably mounting the energy generation device 100 to and/or with respect to the foundation 150. In further embodiments, the system may also include an energy collection device, such as a battery 155, which may be connected to the foundation 150 and/or configured to collect and/or store energy generated by the system. In some embodiments, the foundation 150 may be or include a motor (e.g., including a gearbox) to harness the energy generated by the system and/or transfer that energy to the battery 155 for storage and/or later use. In some embodiments, the foundation 150 may be weighted to allow for the energy generation device 100 to rest and/or operate in the operational position 105 without the system tipping over.

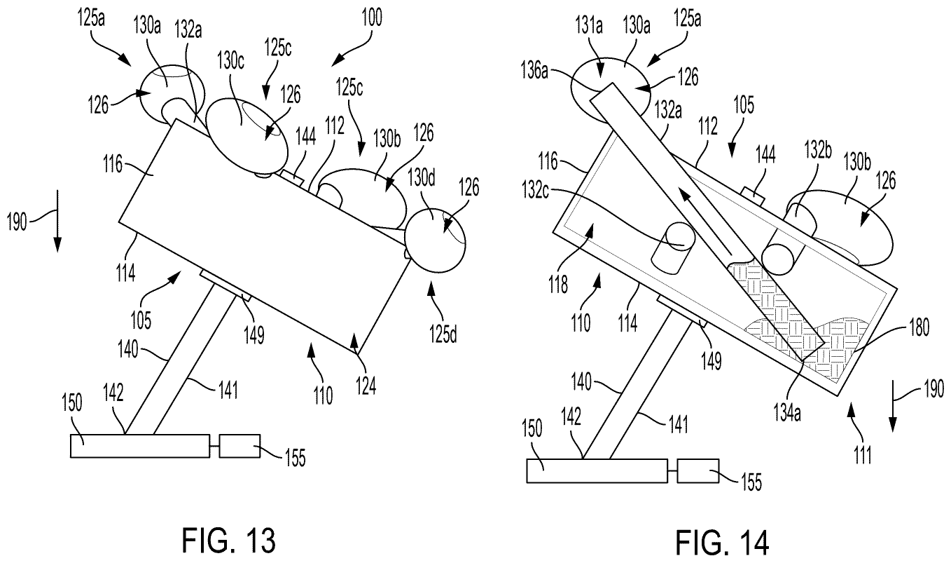

In some embodiments, the energy generation device 100 may be rotatably mounted on, attached to, connected to, made integral with, and/or otherwise fixed with respect to the shaft 140. In the example, the shaft 140 may include a body 141 having a first end 142 and a second end 144. In an embodiment, the body 141 may extend through the through-hole 120, such that the first end 142 is rotatably connected to the foundation and the second end 144 is present within the through-hole 120 or protrudes from the through-hole 120 on an opposite side of the energy generation device 100 from the first end 142. In the embodiment shown, the energy generation device 100 is mounted to the shaft 140 using an optional support element 149 extending from the shaft 140, as shown in FIGS. 13-14.

However, the energy generation device may be attached to the shaft 140 in a variety of ways, including in the absence of the optional support element 149. For example, in some embodiments the shaft 140 may only extend partially through the through-hole 120. In even further embodiments, such as those which lack the through-hole 120 (not shown), the second end 144 of the shaft 140 may be attached directly to the bottom 114 of the body 110, or may be inserted into and/or connected to a recess in the bottom 114 of the body 110. In even further embodiments, the shaft 140 may be made integral with the energy generation device 100. In even further embodiments, the body 141 of the shaft 140 may taper and/or narrow inwardly from the first end 142 towards the second end 144 (not shown), and the through-hole 120 may similarly be tapered (not shown) so as to narrow from an opening on the bottom 114 of the body 110 towards an opening on the top 112 of the body 110 such that the energy generation device 100 may rest on the tapered portion of the body 141. In such an embodiment, the energy generation device 100 may rest just above a portion of the tapered body 141 which has a diameter that is wider than the corresponding diameter of the through-hole 120. In embodiments in which the shaft 140 is not made integrally with the body 110, various connection means may be employed to fix the energy generation device 100 with respect to the shaft 140, such as adhesives, friction-fitting, or other conventional means.

As noted above, the shaft 140 may be rotatably connected to the foundation 150, which in this embodiment may be or include a motor. In an embodiment, the shaft 140 may be configured (e.g., sized, shaped and/or dimensioned) to transfer the rotational force(s) generated by the rotational movement(s) of the energy generation device 100 during operation of the system to and/or onto the motor and/or foundation 150. In an example, the rotational force generated by the energy generation device 100 may be imparted onto one or more gears of a gearbox (not shown) in the motor and/or foundation 150, generating mechanical energy and/or power that may then be converted to electrical energy and/or power. Such electrical energy may be collected and/or stored in the battery 155 for later use.

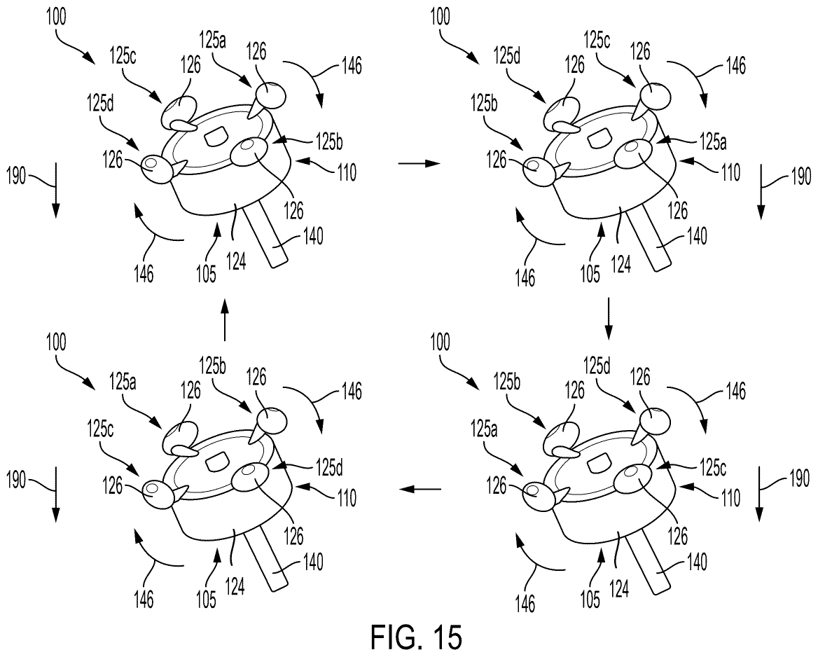

When the energy generation device 100 is attached to the shaft 140 and in the operational configuration and/or position 105, the energy generation device 100 may be rotated in a first rotational direction 146 to generate energy that is transferred to the motor and/or foundation 150, as shown in FIG. 15. The mechanism(s) by which the energy generation device 100 may be rotated to generate energy will now be described. Specifically, the system of the present disclosure may utilize differences in pressure and/or temperature to create and/or drive the rotational movement(s) and/or force(s) of the energy generation device 100. For example, differences in pressure between the primary chamber 118 and at least one of the secondary chambers 131 at any one point in time may be used in combination with the fluid 180 (e.g., using phase-change principles) to create at least a partial rotational movement of the energy generation device 100.

In the embodiment shown in FIGS. 12-15, a temperature differential between the primary chamber 118 and at least one of the secondary chambers 131 may be generated using solar energy as at least an initial input to create pressure differences and/or differentials required for the energy generation device 100 to generate energy. For example, the system may be placed outside in direct sunlight such that the energy generation device 100 is exposed to the direct sunlight. In such an example, the body 110 of the energy generation device 100 may be covered, coated, and/or otherwise imbued (e.g., manufactured) with a first material and/or color 124 (e.g., paint(s) and/or color-dyed polymer(s)), and at least a portion of the extension members 125 (e.g., the heads 130 and/or the stems 132) may be covered, coated, and/or otherwise imbued (e.g., manufactured) with a second material and/or color 126 (e.g., paint(s) and/or color-dyed polymer(s)) that is a lesser conductor of heat than the first material and/or color 124. In certain embodiments, it may be possible to select the first material and/or color 124 that is a better conductor of heat than the natural material(s) making up the extension members 125 or any portion(s) thereof, such that the necessary temperature and/or pressure differentials may only require adding the first material and/or color 124 to the body 110 and not using the second material and/or color 126 at all. Alternatively, it may be possible in some embodiments to select the second material and/or color 126 that is a lesser and/or less efficient conductor of heat than the natural material(s) making up the body 110 or any portion(s) thereof, such that the necessary temperature and/or pressure differentials may only require adding the second material and/or color 126 to the extension members 125 and not using the first material and/or color 124 at all.

In an example where the energy generation device 100 is coated in colored paints, the body 110 may be painted with the first material and/or color 124 that is a darker color than are the extension members 125 (or any portion(s) thereof) and/or the second material and/or color 126. Importantly, in such an embodiment, greater differences in heat conductivity between the first material 124 and the second material 126 may result in the system functioning more efficiently to generate energy. Specifically, greater differences in heat conductivity between the body 110 and/or the primary chamber 118 as compared to at least one of the extension members 125 (e.g., at least one of the heads 130, stems 132 and/or secondary chambers 131) may better facilitate the temperature and/or pressure differentials needed to generate rotational movement(s) of the energy generation device 100. For example, it may be preferable when using paint(s) that the body 110 be painted black and the extension members 125 (or one or more portion(s) thereof) be painted white, as the color black conducts heat far more readily than the color white, and the combination of these colors when used as described may function to generate temperature and/or pressure differences more efficiently than most if not all other color combinations. However, other materials and/or colors may be used to drive differences in heat, heat conductivity and/or pressure within the energy generation device 100, as well as other components and/or elements such as thermally conductive rods, one or more thermoelectric heat pump(s) (e.g., Peltier device(s)), and so forth as explained in more detail below. For illustrative purposes, the example embodiment shown in FIGS. 12-15 is first described as having the first color and/or material 124 on the body 110, and the second color and/or material 126 on at least each of the heads 130 of the extension members 125.

Even further, it may be advantageous to take measures to insulate at least the body 110, such that the body 110 may be configured (e.g., sized, shaped, and/or dimensioned) to retain as much of the heat absorbed into the primary chamber 118 as possible, which may increase the efficiency of the energy generation device 100 by further maintaining desired temperature differentials within the body 110 as compared to any or all of the extension members 125. In the example above, an insulating spray may be used on the body 110, such as prior to the application of black paint.

Continuing on with the example, the energy generation device 100 is shown in FIGS. 12-15 on the shaft 140 and in the operational position 105, with the first extension member 125a extending out and substantially upwardly from the body 110, such that the first head 130a is positioned above or substantially above the body 110 and the first primary opening 134a of the first stem 132a is completely submerged in the fluid 180 (e.g., the fluid 180 that is in liquid form), as best shown in FIG. 14. As the energy generation device 100 is exposed to sunlight, the first material 124 may absorb more heat than the second material 126, which may increase the temperature in the primary chamber 118 as compared to the first secondary chamber 131a. Said another way, as the energy generation device 100 is exposed to sunlight, the body 110 may absorb more heat than the first extension member 125a (e.g., the first head 130a and/or the first stem 132a). As the temperature rises, the fluid 180 may begin to expand and/or evaporate (e.g., some of the fluid 180 may convert from a liquid to a gas and/or vapor), which may increase the pressure in at least the primary chamber 118 as compared to the first secondary chamber 131a. As pressure in the primary chamber 118 increases, at least some of the fluid 180 (e.g., in liquid form) may be pushed and/or drawn up towards and/or into the first head 130a (e.g., towards and/or into the first secondary chamber 131a), as shown in FIG. 14. Eventually, the fluid 180 (e.g., in liquid form) may reach and begin to occupy and/or fill at least a portion of the first secondary chamber 131a in the first head 130a.

As noted above, while the extension members 125 may be substantially balanced with respect to the longitudinal axis 102 and/or arranged radially symmetrically with respect to each other about the body 110, the heads 130 (including the secondary chambers 131) and respective stems 132 of each of the extension members 125 may be offset with respect to each other. Thus, in the example depicted in FIGS. 1-15, the first stem 132a may have an offset connection to the first head 130a, such that the weight of the first head 130a may be biased towards one side of the first stem 132a. As a result, the weight of the fluid 180 (e.g., in liquid form) being pushed and/or drawn up towards and/or into the first secondary chamber 131a may amplify a weight imbalance of the first head 130a with respect to the first stem 132a, causing the first extension member 125a to tip, fall, move, swing and/or rotate in the first rotational direction 146. This movement of the first extension member 125a may cause at least a partial rotational movement of the body 110 about the longitudinal axis 102, the through-hole 120, and/or the shaft 140. Also, as the first extension member 125a tips, the first primary opening 134a may tilt out of the pooled fluid 180 remaining in the primary chamber 118. Such tilting may break a barrier and/or seal formed by the fluid 180 (e.g., the fluid 180 in liquid form between the primary chamber 118 and the first secondary chamber 131a), which may cause the pressure in at least the primary chamber 118 and the first secondary chamber 131a to equalize, and at least a majority of the fluid 180 (e.g., in liquid form) that was drawn up towards and/or into the first secondary chamber 131a to flow back towards and/or into the primary chamber 118. In the example, the tipping of the first extension member 125a in the first rotational direction 146 (e.g., caused by the fluid 180 being pushed and/or drawn up towards and/or into the first head 130a) may cause a rotational and/or turning movement of the body 110, which may be transferred through the shaft 140 to the foundation 150 (e.g., to the motor) and/or the battery 155.

In the example shown, the rotational movement of the energy generation device 100 resulting from the tipping of the first extension member 125a as just described may be a one quarter rotation (e.g., a 90 degree rotation) or about a one quarter rotation of the energy generation device 100 about the shaft 140 and/or the longitudinal axis 102. However, in other embodiments, particularly those with more or less extension members, the rotational movement of the energy generation device caused by a tipping extension member may be a different amount, such as a one-half or one-third quarter turn, among what are likely countless other possible configurations. Notably, in the example, at least a small portion of the fluid 180 (e.g., in liquid form) may remain in the first secondary chamber 131a following the roughly one quarter rotation as just described. The small portion of the fluid 180 in the first secondary chamber 131a may increase a surface area of the fluid 180, promoting evaporation of the fluid 180 (e.g., in response to heat).

Once the energy generation device 100 completes a one quarter movement as just described, the system may repeat the process with respect to a different extension member 125. In the example shown in FIG. 15, as the first extension member 125a comes to a stop and/or rest (e.g., after the one-quarter turn is completed), the third extension member 125c may take the original position of the first extension member 125a. Specifically, the third extension member 125c may extend out and substantially upwardly from the body 110, such that the third head 130c may be positioned above or substantially above the body 110 and the third primary opening 134c of the third stem 132c may be submerged in and/or below a surface level of the fluid 180 (e.g., in liquid form). From this position, the heat transfer process which drives the pressure differences in the energy generation device 100 may repeat. For example, the primary chamber 118 may conduct more heat than does the third extension member 125c (or any portion(s) thereof), creating a pressure difference which pushes and/or draws the fluid 180 (e.g., in liquid form) up towards and/or into the third head 130c (e.g., towards and/or into the third secondary chamber 131c).

As the fluid 180 (e.g., in liquid form) reaches and/or begins to fill and/or occupy at least a portion of the third secondary chamber 131c (e.g., in the third head 130c), the weight of the fluid 180 may amplify the weight imbalance of the third head 130c with respect to the third stem 132c, causing the third extension member 125c to tip in the first rotational direction 146. As the third extension member 125c tips, the third primary opening 134c may tilt out of the pooled fluid 180 (e.g., in liquid form) remaining in the primary chamber 118, causing the pressure in at least the primary chamber 118 and the third secondary chamber 131c to equalize and at least a majority of the fluid 180 (e.g., in liquid form) that was drawn up towards and/or into the third secondary chamber 131c to flow back into the primary chamber 118. In the example, the tipping of the third extension member 125c in the first rotational direction 146 may cause a rotational and/or turning movement of the body 110, which may again be transferred through the shaft 140 to the foundation 150 (e.g., to the motor).

At this point during operation of the system, the energy generation device 100 may have completed another one-quarter turn, for a total of a one-half rotation (e.g., 180 degrees) about the shaft 140 and/or the longitudinal axis 102. Notably, small portions of the fluid 180 may remain in the first secondary chamber 131a and/or the third secondary chamber 131c at this point, effectively increasing a surface area of the fluid 180 and promoting evaporation thereof (e.g., in response to heat). Once the energy generation device 100 completes a one quarter movement as just described, the system may repeat the process with respect to a different extension member 125. As shown in FIG. 15, as the third extension member 125c comes to a stop and/or rest (e.g., after the one-half turn from the original position is completed), the fourth extension member 125d may take the original position of the first extension member 125a. Specifically, the fourth extension member 125d may out and substantially upwardly from the body 110, such that the fourth head 130d is positioned above or substantially above the body 110 and the fourth primary opening 134d is of the fourth stem 132d is submerged in the fluid 180 (e.g., in liquid form). From this position, the heat transfer process which drives the pressure differences in the energy generation device 100 may repeat. For example, the primary chamber 118 may conduct more heat than does the fourth extension member 125d (or any portion(s) thereof), creating a pressure difference which draws the fluid 180 (e.g., in liquid form) up towards and/or into the fourth head 130d (e.g., towards and/or into the fourth secondary chamber 131d).

As the fluid 180 (e.g., in liquid form) reaches and/or begins to fill and/or occupy at least a portion of the fourth secondary chamber 131d (e.g., in the fourth head 130d), the weight of the fluid 180 may amplify the weight imbalance of the fourth head 130d with respect to the fourth stem 132d, causing the fourth extension member 125d to tip in the first rotational direction 146. As the fourth extension member 125d tips the fourth primary opening 134d may tilt out of the pooled fluid 180 (e.g., in liquid form) remaining in the primary chamber 118, causing the pressure in at least the primary chamber 118 and the fourth secondary chamber 131d to equalize and at least a majority of the fluid 180 (e.g., in liquid form) that was drawn up towards and/or into the fourth secondary chamber 131d to flow back into the primary chamber 118. In the example, the tipping of the fourth extension member 125d in the first rotational direction 146 may cause a rotational and/or turning movement of the body 110, which may again be transferred through the shaft 140 to the foundation 150 (e.g., to the motor).

At this point during operation of the system, the energy generation device 100 has completed another one-quarter turn, for a total of a three-quarters rotation (e.g., 270 degrees) about the shaft 140 and/or the longitudinal axis 102. Notably, small portions of the fluid 180 may remain in the third secondary chamber 131c and the fourth secondary chamber 131d at this point, effectively increasing a surface area of the fluid 180 and promoting evaporation thereof (e.g., in response to heat). However, due to the configuration (e.g., sizing, shaping, and/or dimensioning) of the first head 130a relative to the first stem 132a, at least some of the small portion of the fluid 180 remaining in the first secondary chamber 131a may flow through the first stem 132a towards and/or into the body 110 (e.g., the primary chamber 118). That is, due to the offset connection of the first head 130a to the first stem 132a, gravity may pull at least some of the small portion of the fluid 180 in the first secondary chamber 131a towards and/or into the primary chamber 118. Once the energy generation device 100 completes a one quarter movement as just described, the system may repeat the process with respect to a different extension member 125. In the example shown in FIG. 15, as the fourth extension member 125d comes to a stop and/or rest (e.g., after the three-quarters turn from the original position is completed), the second extension member 125b may take the original position of the first extension member 125a. Specifically, the second extension member 125b may extend out and substantially upwardly from the body 110, such that the second head 130b may be positioned above or substantially above the body 110 and the second primary opening 134b of the second stem 132b is submerged in the fluid 180 (e.g., in liquid form). From this position, the heat transfer process which drives the pressure differences in the energy generation device 100 may repeat. For example, the primary chamber 118 may conduct more heat than does the second extension member 125b (or any portion(s) thereof), creating a pressure difference which draws the fluid 180 (e.g., in liquid form) up towards and/or into the second head 130b (e.g., towards and/or into the second secondary chamber 131b).

As the fluid 180 (e.g., in liquid form) reaches and/or begins to fill and/or occupy at least a portion of the second secondary chamber 131b (e.g., in the second head 130b), the fluid 180 may amplify the weight imbalance of the second head 130b with respect to the second stem 132b, causing the second extension member 125b to tip in the first rotational direction 146. As the second extension member 125b tips, the second primary opening 134b may tilt out of the pooled fluid 180 (e.g., in liquid form) remaining in the primary chamber 118, causing the pressure in at least the primary chamber 118 and the second secondary chamber 131b to equalize and at least a majority of the fluid 180 (e.g., in liquid form) that was drawn up toward and/or into the second secondary chamber 131b to flow back into the primary chamber 118. In the example, the tipping of the second extension member 125b in the first rotational direction 146 may cause a rotational and/or turning movement of the body 110, which may again be transferred through the shaft 140 to the foundation (e.g., to the motor).

At this point during operation of the system, the energy generation device 100 may have completed another one-quarter turn, and has thus completed one full rotation (e.g., 360 degrees) about the shaft 140 and/or longitudinal axis 102. Notably, small portions of the fluid 180 may remain in the second secondary chamber 131b and/or the fourth secondary chamber 131d at this point, effectively increasing a surface area of the fluid 180 and promoting evaporation thereof (e.g., in response to heat). However, due to the configuration (e.g., sizing, shaping, and/or dimensioning) of the third head 130c relative to the third stem 132c, at least some of the small portion of the fluid 180 remaining in the third secondary chamber 131c may flow through the third stem 132c towards and/or into the primary chamber 118.

As shown in FIG. 15, as the second extension member 125b comes to a stop and/or rest (e.g., after the full turn from the original position is completed), the first extension member 125a may return to its original position, e.g., extending out and substantially upwardly from the body 110, such that the first head 130a is positioned above or substantially above the body and the first primary opening 134a of the first stem 132a is submerged in the fluid 180 (e.g., in liquid form). The only difference between the system during startup and the system as it comes to a rest following its first rotation is that, as the system completes its first rotation, small portions of the fluid 180 may remain in some of the secondary chambers 131 as described above. From this position, the process of the system as just described may repeat indefinitely and/or as needed (e.g., while a temperature differential is maintained) to generate energy from rotational and/or turning movements of the energy generation device 100. Pressure differentials which drive the rotational and/or turning movements of the energy generation device 100 may continue to develop as long as there is sufficient heat present in the system.

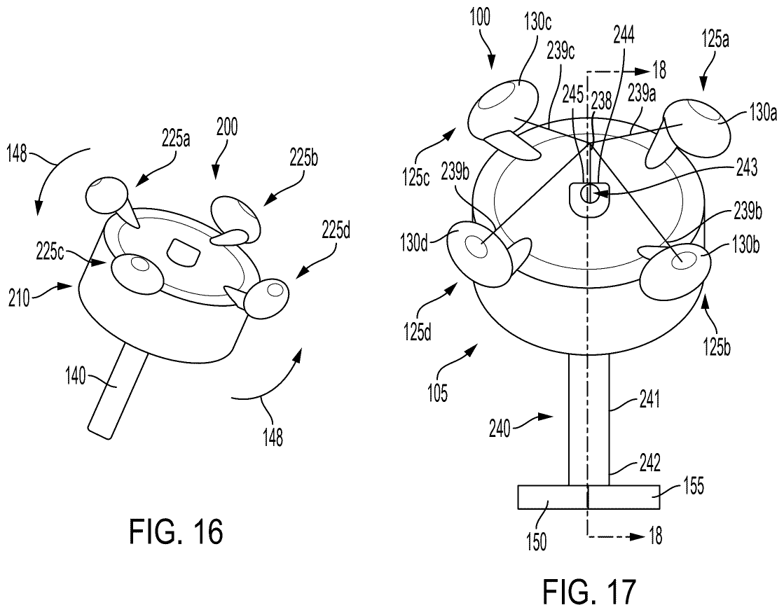

In other embodiments of the system and/or the energy generation device, the energy generation device may be configured (e.g., sized, shaped, and/or dimensioned) to rotate in a second rotational direction 148 that is opposite the first rotational direction 146 to generate energy. For example, FIG. 16 shows a portion of an alternative system for generating energy according to aspects disclosed herein which uses a second energy generation device 200 mounted on the shaft 140. The second energy generation device 200 may include a body 210 that is identical to the body 110 of the energy generation device 100. However, the second energy generation device 200 may also feature a second plurality of extension members 225. The second plurality of extension members 225 may include a second plurality of heads 230, wherein each head of the secondary plurality of heads 230 is attached to a respective stem of a second plurality of stems 232. As shown in FIGS. 15-16, each of the heads 230 may be biased and/or offset to an opposite side of each of the respective stems 225s as compared to the plurality of extension members 125. In such an embodiment of the energy generation device 200, the extension members 225 may be configured to tip in the second rotational direction 148, while otherwise functioning identically to the energy generation device 100. In some embodiments, there may be other slight differences necessary for proper functioning of the device, such as the configuration (e.g., sizing, shaping and/or dimensioning) of the foundation 150 to receive the rotational force(s) of the energy generation device 200 from the shaft 140 in the second rotational direction 148 as opposed to the first rotational direction 146.

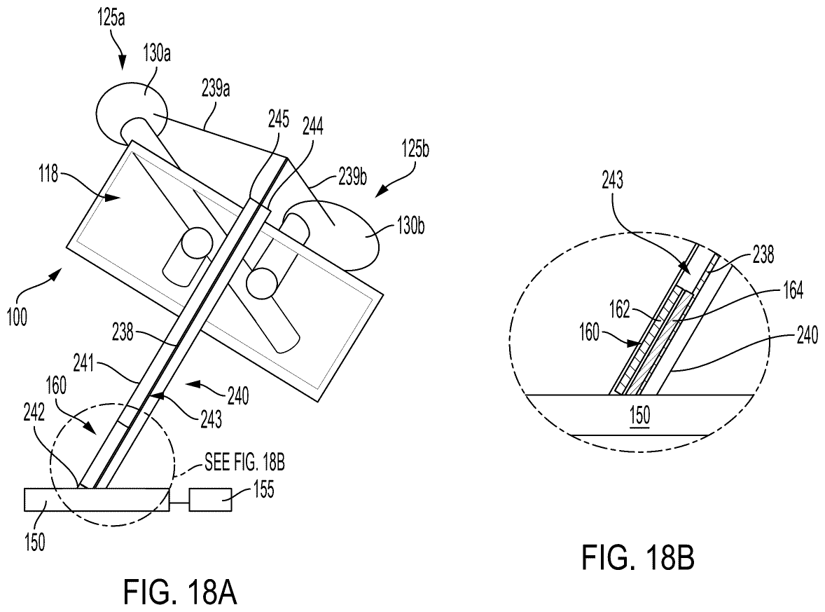

Turning to FIGS. 17-18, another alternative embodiment of the system is described. In the alternative embodiment, the system may include the energy generation device 100 (or the energy generation device 200, or another embodiment described herein), the fluid 180 (e.g., inside the energy generation device 100), the foundation 150 (e.g., the motor), and the battery 155. However, this embodiment of the system may further include a shaft 240 which may be different from the shaft 140. Specifically, the shaft 240 may have a cavity 243 extending through at least a portion of the shaft 240. In the example, the cavity 243 extends from at or near a first end 242 of the shaft 240 to an opening 245 in a second end 244 of the shaft 240. Further, this embodiment of the system may include a thermoelectric heat pump 160 (e.g., a Peltier device) and/or a plurality of thermally conductive rods, as described in more detail below. In further embodiments (not shown), a plurality of thermoelectric heat pumps may be used to perform the function of the thermoelectric heat pump 160. The shaft 240 may enable for structures to be formed, placed and/or positioned within the cavity 243, including elements which may not be intended to rotate (e.g., at all or at the same speed as the shaft 240) or elements meant to transfer heat to one or more specific locations on, around and/or within the system, as explained in more detail below.

The thermoelectric heat pump 160 may be used to maintain and/or increase the temperature differential of the system as described above, recognizing that doing so consumes a portion of the power generated by the system. For example, the thermoelectric heat pump 160 may be configured (e.g., sized, shaped, and/or dimensioned) to use the thermoelectric effect or a portion thereof (e.g., the Peltier effect) to enhance the efficiency of the system by transferring heat to the body 110 and/or by cooling (e.g., transferring heat away from) one or more of the extension members 125 or any portion(s) thereof. In an embodiment, the thermoelectric heat pump 160 may use energy generated by the system (e.g., by the rotational movement(s) of the energy generation device 100) for power. For example, the thermoelectric heat pump 160 may be supplied with energy from the foundation 150 (e.g., the motor) and/or the battery 155 which derives from and/or was generated by the rotational movements and/or force(s) of the energy generation device 100 during operation of the system as described above.

In the example shown in FIGS. 18a-18b, the thermoelectric heat pump 160 may include a heating portion 162 and a cooling portion 164. The thermoelectric heat pump 160 may further include and/or be connected to various conduits to permit the thermoelectric heat pump 160 to receive power from the foundation 150 (e.g., the motor) and/or the battery 155, as well as to transfer heat throughout the system as desired. The heating portion 162 may be configured (e.g., sized, shaped, and/or dimensioned) to transfer heat to the body 110 and/or the inner chamber 119, and the cooling portion 164 may be configured (e.g., sized, shaped, and/or dimensioned) to transfer heat away from (e.g., cool) one or more of the extension members 125 or some portion(s) thereof (e.g., the heads 130 and/or the stems 132).

In the example embodiment shown in FIGS. 17-18, the thermoelectric heat pump 160 is located within the cavity 243 of the shaft 240. The thermoelectric heat pump 160 may be positioned such that the heating portion 162 contacts and/or transfers heat to the body 241 of the shaft 240 and/or such that the cooling portion 164 contacts and/or transfers heat from a central thermally conductive rod or extension 238 extending through at least a portion of the cavity 243. The contact between the heating portion 162 and the body 241 of the shaft 240 may enable the transfer of heat from the heating portion 162 up the shaft 240 to the body 110 of the energy generation device 100 (e.g., to the primary chamber 118) to increase the temperature and/or the pressure therein. To facilitate this heat transfer, the shaft 240 may accordingly be made and/or formed (or partially made and/or formed) of a thermally conductive material.

The central thermally conductive extension 238 may extend from the thermoelectric heat pump 160 to and/or through the opening 245 in the second end 244. The central thermally conductive extension 238 may further be connected to one or more of thermally conductive extensions 239 which may enable the transfer of heat between (e.g., to and/or from) the thermoelectric heat pump 160 and any of the extension members 125. For example, the central thermally conductive extension 238 may be connected to the first extension member 125a (e.g., the first head 130a and/or the first stem 132a) by a first thermally conductive extension 239a; the central thermally conductive extension 238 may be connected to the second extension member 125b (e.g., the second head 130b and/or the second stem 132b) by a second thermally conductive extension 239b; the central thermally conductive extension 238 may be connected to the third extension member 125c (e.g., the third head 130c and/or the third stem 132c) by a third thermally conductive extension 239c; and the central thermally conductive extension 238 may be connected to the fourth extension member 125d (e.g., the fourth head 130d and/or the fourth stem 132d) by a fourth thermally conductive extension 239d. In the example shown in FIG. 17, each of the heads 130 of the extension members 125 may be connected to one of the thermally conductive extensions 239. Such connections may enable the transfer of heat away from the extension members 125, which may lower the temperature(s), and thus the pressure(s), therein (e.g., within the secondary chambers 131) and/or with respect to the primary chamber 118. In some embodiments, the thermally conductive extensions 239 may be configured (e.g., sized, shaped, and/or dimensioned) and/or positioned so as not to disturb or substantially disturb the radial balancing of the energy generation device 100 as described above, as weight imbalances may interfere with the ability of the energy generation device 100 to turn and/or rotate.

The inclusion, configuration and/or positioning of the thermoelectric heat pump 160 within the system may increase the efficiency of the system during operation. As described above, the rotational movement and/or force of the energy generation device 100 is driven by differences in pressure which are caused by heat differentials within the primary chamber 118 as compared to any one of the secondary chambers 131 (e.g., the secondary chamber of whichever head is actively in the process of drawing up the fluid 180 (e.g., in liquid form) as described above with reference to FIG. 15). Thus, by using energy generated by the system to power the thermoelectric heat pump 160, the system may further drive the desired pressure and/or heat differential(s) by increasing the temperature (and thus the pressure) of the primary chamber 118 and/or decreasing the temperature (and thus the pressure) of at least one of the secondary chambers 131, further catalyzing the pressure changes which draw up the fluid 180 (e.g., in liquid form) and cause the energy generation device 100 to turn and/or rotate.

Notably, in some embodiments, a heater (not shown) maybe used instead of the thermoelectric heat pump 160, such that the heater only applies heat to the body 110 (e.g., the primary chamber 118) without also cooling (e.g., transfer heat away from) any of the extension members 125 (e.g., the heads 130 and/or the stems 132), as such an embodiment would still catalyze the desired temperature differentials (and corresponding pressure differentials) needed to draw up the fluid 180 (e.g., in liquid form) into any of the secondary chambers 131 as described above. Similarly, in some embodiments, the a cooler (not shown) may be used instead of the thermoelectric heat pump 160, such that the cooler may only cool (e.g., to transfer away from) at least one of the extension members 125 (e.g., the heads 130 and/or the stems 132), without also heating the body 110 (e.g., the primary chamber 118), as such an embodiment would also still catalyze the desired temperature differentials (and corresponding pressure differentials) needed to draw up the fluid 180 (e.g., in liquid form) into any of the secondary chambers 131 as described above. However, such embodiments using a heater or a cooler may be inefficient compared to embodiments using the thermoelectric heat pump 160.

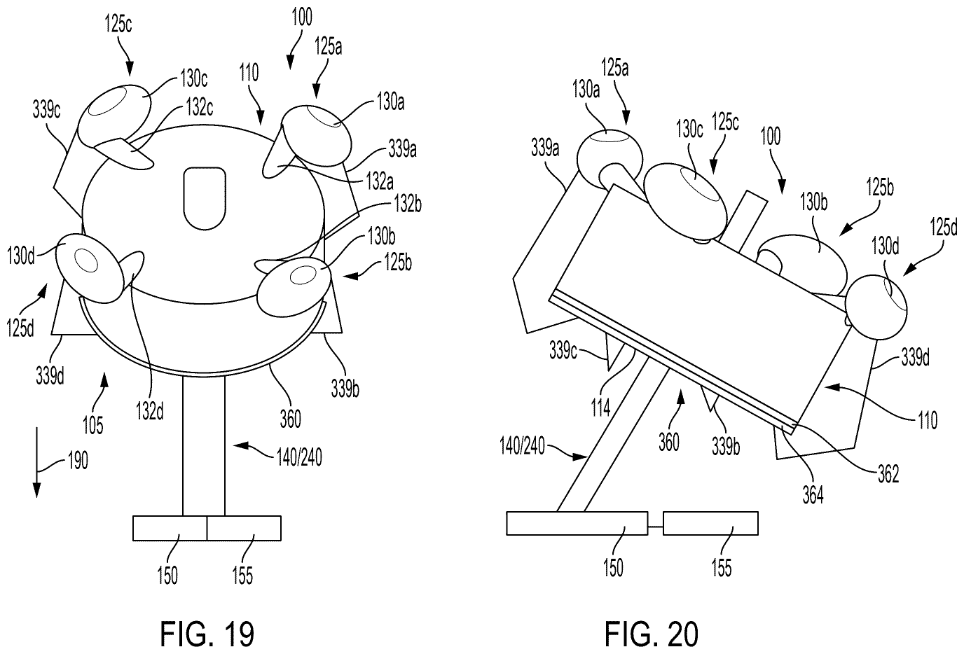

There may be alternative configurations and/or embodiments of the system which utilize thermoelectric heat pumps (e.g., the thermoelectric heat pump 160 or variations thereof). For example, FIGS. 19-20 show an alternative embodiment of the system which includes the energy generation device 100 (or the energy generation device 200, or another embodiment described herein) the fluid 180 (e.g., inside the energy generation device 100), the foundation 150 (e.g., the motor), and the battery 155. This embodiment of the system may also include the shaft 140 or the shaft 240, depending on how connections between the shaft 140/240 and a thermoelectric heat pump 360 are facilitated (e.g., whether the embodiment requires the shaft 240 having the cavity 243 as a means of accessing power from the foundation 150 and/or the battery 155). Also in this embodiment, the thermoelectric heat pump 360 may be used in combination with one or more thermally conductive rods or extensions 339.

The thermoelectric heat pump 360 may include a warm and/or heating portion 362 and a cooling portion 364, and may further be configured (e.g., sized shaped, and/or dimensioned) and/or positioned to use the thermoelectric effect or a portion thereof (e.g., the Peltier effect) to enhance the efficiency of the system by transferring heat to the body 110 and/or by cooling (e.g., transferring heat away from) one or more of the extension members 125 or any portion(s) thereof (e.g., the heads 130 and/or the stems 132). In the example, the thermoelectric heat pump 360 may differ from the thermoelectric heat pump 160 in size, shape, location and/or position. For example, the thermoelectric heat pump 360 may be configured (e.g., sized, shaped, and/or dimensioned) such that the heating portion 362 may contact, cover, and/or otherwise connect directly to the bottom 114 of the energy generation device 100 or a portion thereof, as best shown in FIG. 20. This position may effectively allow for the thermoelectric heat pump 360 to transfer energy to the body 110, and thus to at least the primary chamber 118, which may increase the temperature (and thus also the pressure) therein to create and/or drive the rotational movement(s) and/or force(s) of the energy generation device 100 during operation of the system. While in FIGS. 19-20 the heating portion 362 of the thermoelectric heat pump 360 is shown covering an entirety of the bottom 114 of the energy generation device 100, in other embodiments the thermoelectric heat pump 360 may cover only a portion of the bottom 114. However, in either embodiment, the heating portion 362 may be configured (e.g., sized, shaped, and/or dimensioned) and/or positioned to transfer heat to the body 110 to bolster the desired heat differentials between the primary chamber 118 and at least one of the secondary chambers 131 when the system is in operation.

Continuing with the example shown in FIGS. 19-20, the cooling portion 364 of the thermoelectric heat pump 360 may be connected to the one or more thermally conductive extensions 339. Specifically, each of the one or more thermally conductive extensions 339 may facilitate a heat transfer between at least one of the extension members 125 (e.g., the heads 130 and/or the stems 132) of the energy generation device 100 and the cooling portion 364 of the thermoelectric heat pump 360. For example, a first thermally conductive extension 339a may connect and/or facilitate a heat transfer between the cooling portion 364 and the first extension member 125a (e.g., the first head 130a and/or the first stem 132a); a second thermally conductive extension 339b may connect and/or facilitate a heat transfer between the cooling portion 364 and the second extension member 125b (e.g., the second head 130b and/or the second stem 132b); a third thermally conductive extension 339c may connect and/or facilitate a heat transfer between the cooling portion 364 and the third extension member 125c (e.g., the third head 130c and/or the third stem 132c); and a fourth thermally conductive extension 339d may connect and/or facilitate a heat transfer between the cooling portion 364 and the fourth extension member 125d (e.g., the fourth head 130d and/or the fourth stem 132d). Such connections may enable the transfer of heat away from any or all the extension members 125, lowering the temperature, and thus the pressure, therein (e.g., in the secondary chambers 131). In some embodiments, there may be less than four thermally conductive extensions 339, depending on a variety of factors including the number of extension members 125, weight/balance considerations, and the like.

In an embodiment, the thermoelectric heat pump 360 may use energy generated by the system (e.g., by the turning and/or rotational movement(s) of the energy generation device 100) for power. For example, the thermoelectric heat pump 360 may be supplied through the cavity 243 of the shaft 240 with energy from the foundation 150 (e.g., the motor) and/or the battery 155 which derives from and/or was generated by the rotational movements and/or force(s) of the energy generation device 100 during operation of the system as described above. Similarly to the embodiments above, the inclusion, configuration and/or positioning of the thermoelectric heat pump 360 within the system may increase the efficiency of the system during operation. Specifically, by using energy generated by the system to power the thermoelectric heat pump 360, the system further drives the desired heat differentials by increasing the temperature (and thus the pressure) of the primary chamber 118 and/or decreasing the temperature (and thus the pressure) of at least one of the secondary chambers 131, further catalyzing the pressure changes which draw up the fluid 180 (e.g., in liquid form) and cause the energy generation device 100 to turn and/or rotate.

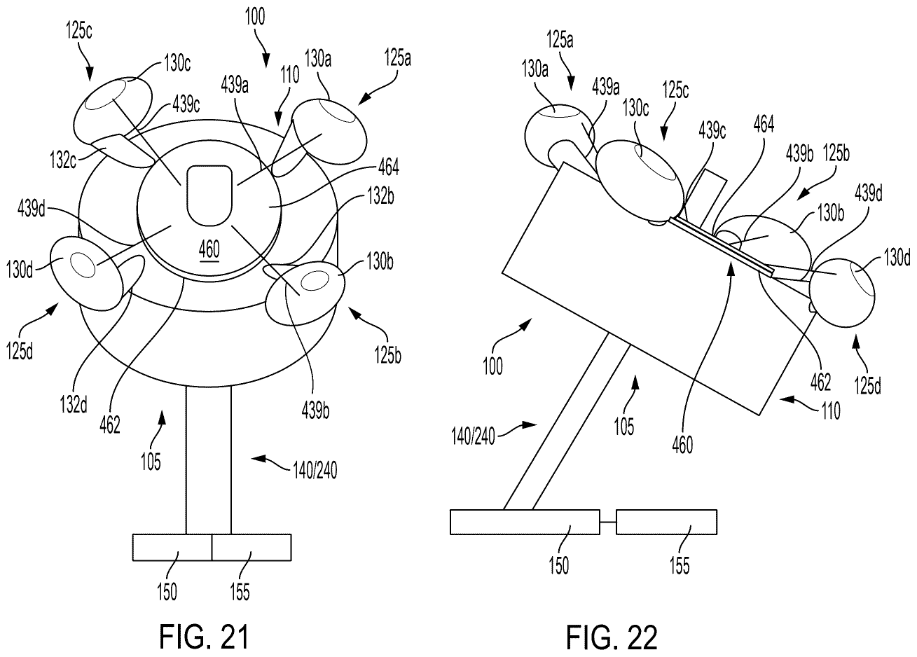

With reference to FIGS. 21-22, yet another alternative embodiment of the system will be described in detail. In the example, the system includes the energy generation device 100 (or the energy generation device 200, or another embodiment described herein) the fluid 180 (e.g., inside the energy generation device 100), the foundation 150 (e.g., the motor), and the battery 155. This embodiment of the system may also include the shaft 140 or the shaft 240, depending on how connections between the shaft 140/240 and a thermoelectric heat pump 460 are facilitated (e.g., whether the embodiment requires the shaft 240 having the cavity 243 as a means of accessing power from the foundation 150 and/or the battery 155). Also in this embodiment, the thermoelectric heat pump 460 may be used in combination with one or more thermally conductive extensions 439.

The thermoelectric heat pump 460 may include a warm and/or heating portion 462 and a cooling portion 464, and may further be configured (e.g., sized shaped, and/or dimensioned) and/or positioned to use the thermoelectric effect or a portion thereof (e.g., the Peltier effect) to enhance the efficiency of the system by transferring heat to the body 110 and/or by cooling (e.g., transferring heat away from) one or more of the extension members 125 or any portion(s) thereof. In the example, the thermoelectric heat pump 460 may differ from the thermoelectric heat pump 160 in size, shape, location and/or position. For example, the thermoelectric heat pump 460 may be configured (e.g., sized, shaped, and/or dimensioned) such that the heating portion 462 may contact, cover, and/or otherwise connect directly to the top 112 of the energy generation device 100 or a portion thereof. This position may effectively allow for the thermoelectric heat pump 460 to transfer energy to the body 110, and thus to at least the primary chamber 118, increasing the temperature (and thus also the pressure) therein and driving the rotational movement(s) and/or force(s) of the energy generation device 100 during operation of the system. While in FIGS. 20-21 the heating portion 462 of the thermoelectric heat pump 460 is shown covering only a portion of the top 112 of the energy generation device 100, in other embodiments the thermoelectric heat pump 460 may cover all of the top 112. However, it may be desirable for the heating portion 462 to avoid the stems 132 so to minimize and/or prevent an undesirable transfer heat to any of the secondary chambers 131. In any case, the heating portion 462 may be configured (e.g., sized, shaped, and/or dimensioned) and/or positioned to transfer heat to the body 110 to bolster the desired heat differentials between the primary chamber 118 and at least one of the secondary chambers 131 when the system is in operation.

Continuing with the example shown in FIGS. 21-22, the cooling portion 464 of the thermoelectric heat pump 460 may be connected to the one or more thermally conductive extensions 449. Specifically, each of the one or more thermally conductive extensions 449 may facilitate a heat transfer between at least one of the extension members 125 (e.g., the heads 130 and/or the stems 132) of the energy generation device 100 and the cooling portion 464 of the thermoelectric heat pump 460. For example, a first thermally conductive extension 439a may connect and/or facilitate a heat transfer between the cooling portion 464 and the first extension member 125a (e.g., the first head 130a and/or the first stem 132a); a second thermally conductive extension 439b may connect and/or facilitate a heat transfer between the cooling portion 464 and the second extension member 125b (e.g., the second head 130b and/or the second stem 132b); a third thermally conductive extension 439c may connect and/or facilitate a heat transfer between the cooling portion 464 and the third extension member 125c (e.g., the third head 130c and/or the third stem 132c); and a fourth thermally conductive extension 439d may connect and/or facilitate a heat transfer between the cooling portion 464 and the fourth extension member 125d (e.g., the fourth head 130d and/or the fourth stem 132d). Such connections may enable the transfer of heat away from any or all the extension members 125, lowering the temperature, and thus the pressure, therein (e.g., in the secondary chambers 131). In some embodiments, there may be less than four thermally conductive extensions 439, depending on a variety of factors including the number of extension members 125, weight/balance considerations, and the like.

In an embodiment, the thermoelectric heat pump 460 may use energy generated by the system (e.g., by the rotational movement(s) of the energy generation device 100) for power. For example, the thermoelectric heat pump 460 may be supplied through the cavity 243 of the shaft 240 with energy from the foundation 150 (e.g., the motor) and/or the battery 155 which derives from and/or was generated by the rotational movements and/or force(s) of the energy generation device 100 during operation of the system as described above. Similarly to the embodiments above, the inclusion, configuration and/or positioning of the thermoelectric heat pump 460 within the system may increase the efficiency of the system during operation. Specifically, by using energy generated by the system to power the thermoelectric heat pump 460, the system further drives the desired heat differentials by increasing the temperature (and thus the pressure) of the primary chamber 118 and/or decreasing the temperature (and thus the pressure) of at least one of the secondary chambers 131, further catalyzing the pressure changes which draw up the fluid 180 (e.g., in liquid form) and cause the energy generation device 100 to rotate.

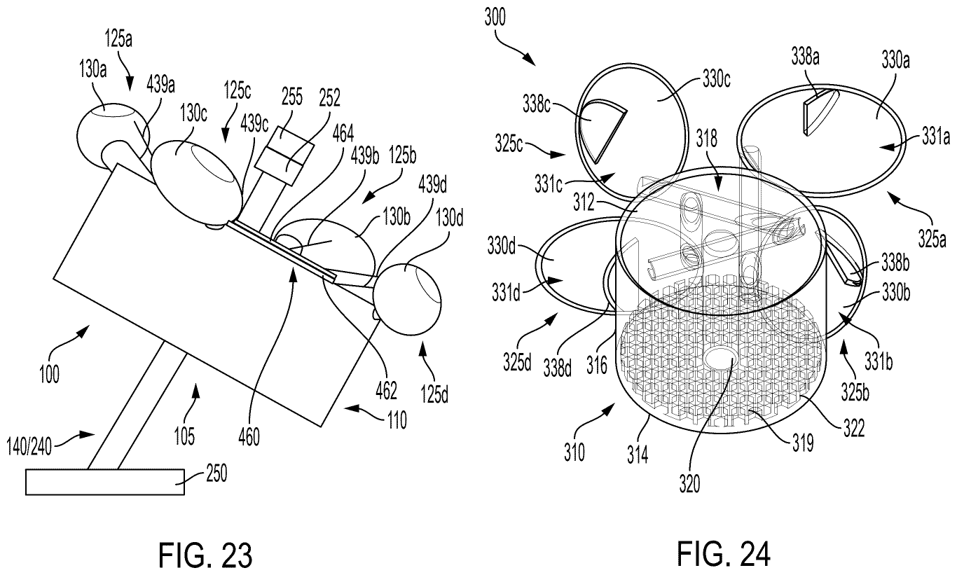

It should be noted that in at least some embodiments of the system, the shaft (e.g., the shaft 140 or the shaft 240) may be mounted to a foundation which does not include a motor and/or a battery (e.g., the battery 155). For example, as shown in FIG. 23, the energy generation device 100 or variations thereof (e.g., the energy generation device 200 or other embodiments according to aspects disclosed herein) may be mounted (e.g., rotatably mounted) on the shaft 140, 240, which may be connected to a foundation 250. The foundation 250 may be a simple structure that is configured (e.g., sized, shaped, and/or dimensioned) to secure the system (e.g., including the shaft 140, 240 and/or the energy generation device 100) relative to a ground, floor, or other surface(s) on which the system may be placed. In an embodiment, the foundation 250 may simply be a metal plate, a wooden board, a plastic block, or a similar structure (e.g., or a combination thereof). In some embodiments, the foundation 250 may be weighted to ensure that the system does not fall over when the energy generation device 100 is in the operational position 105. In other embodiments, the foundation 250 may be secured to the ground, floor, or other surface using conventional means such as nails, screws, adhesives, etc.

In embodiments wherein the foundation 250 lacks a motor and/or a battery, such components may be located elsewhere in the system. For example, a motor 252 and/or a battery 255 may be located on an opposite end of the shaft 140, 240 from the foundation 250, as shown in FIG. 23. Thus, the motor 252 and/or the battery 255 may be located at least partially above the energy generation device 100. In the example, the system includes the thermoelectric heat pump 460, which may be positioned on the top 112 (e.g., FIG. 1) of the body 110. The positioning of at least the motor 252 above the body 110 and close to the thermoelectric heat pump 460 may facilitate connections between the motor 252 and the thermoelectric heat pump 460. As in other embodiments, the motor 252 may be configured (e.g., sized, shaped, and/or dimensioned) to receive a rotational force of the energy generation device 100, and may further be configured (e.g., sized, shaped, and/or dimensioned) to transfer that energy to the battery 255 (e.g., to be collected and/or for later use) or to the thermoelectric heat pump 460 to further drive temperature and/or pressure differentials that may be required for the energy generation device 100 to turn and/or rotate. Where the shaft 240 is used, the motor 252 and/or the battery 255 may be placed on a separate rod or similar structure extending through the shaft 240 (e.g., within the cavity 243 as in FIG. 18), such that the motor 252 and/or the battery 255 do not turn and/or rotate along with the energy generation device 100. In such embodiments, the motor 252 may be configured to receive a rotational force from the shaft 240 without also rotating therewith.

Turning to FIG. 24, one or more additional structures may be included in some embodiments of the energy generation device to enhance the evaporative properties of the system, which may enhance the ability of the system to generate pressure and/or temperature differentials necessary to turn and/or rotate the energy generation device. For example, an energy generation device 300 may include a body 310 connected to a plurality of extension member 325. The body 310 may include a top 312, a bottom 314, and a side 316 extending between the top 312 and the bottom 314. In the embodiment shown, the energy generation device 300 is formed of a substantially clear material such as glass such that the energy generation device 300 is translucent, but it should be understood that the glass surface may be coated with a first material and/or color and/or a second material and/or color to influence the heat conductivity of various components of the energy generation device 300. The body 310 may bound a primary chamber 318 and may optionally include a through-hole 320 or a cavity for mounting the energy generation device 300 as described above with respect to the energy generation devices 100/200.

In some embodiments, the energy generation device 300 may include a first surface enhancing structure 322, for example, on an inner side 319 of the bottom 314 of the body 310. In the embodiment shown in FIG. 24, the first surface enhancing structure 322 may be a hexagonal structure such as a grid (e.g., honeycomb shaped) covering all or substantially all of the inner side 319. The first surface enhancing structure 322 may be configured (e.g., sized, shaped, and/or dimensioned) to capture some of the fluid 180 (e.g., in liquid form) as the energy generation device 300 rotates to generate energy. In the example, the surface enhancing structure 322 may include one or more cavities made up of one or more hexagons. Each of the cavities may be configured (e.g., sized, shaped, and/or dimensioned) hold and/or contain a portion of the fluid 180 (e.g., in liquid form) during operation of the system. This fluid-capturing function may effectively increase the surface area of the fluid 180, which may enhance the speed at which the fluid 180 may evaporate. In other embodiments, different surface enhancing structures may be included in the interior of the energy generation device 300, such as a plurality of folds or cavities having different shapes (e.g., other than hexagons). In further embodiments, there may be additional surface enhancing structures, for example, on an interior of the side 316 of the body 310.

Similarly to other embodiments, the body 310 of the energy generation device 300 may be connected to one or more extension members of the plurality of extension members 325. Each extension member of the plurality of extension members 325 may be connected to the body 310 and may further include at least one bulb and/or head 330 and at least one arm and/or stem 332. For example, the first extension member 325a may include at least a first head 330a and at least a first stem 332a extending from the first head 330a; the second extension member 325b may include at least a second head 330b and at least a second stem 332b extending from the second head 330a; the third extension member 325c may include at least a third head 330c and at least a third stem 332c extending from the third head 330c; and the fourth extension member 325d may include at least a fourth head 330d and at least a fourth stem 332d extending from the fourth head 330.

The heads 330 of the plurality of extension members 325 may each define and/or bound one or more secondary chamber(s) 331. For example, the first head 330a may bound a first secondary chamber 331a; the second head 330b may bound a second secondary chamber 331b; the third head 330c may bound a third secondary chamber 331c; and the fourth head 330d may bound a fourth secondary chamber 331d. Each of the one or more secondary chamber(s) may be in fluid communication with the primary chamber 318.

In the embodiment shown in FIG. 24, each of the heads 330 and/or the secondary chambers 331 may include one or more internal walls, flaps and/or fins 338. For example, the first head 330a and/or the first secondary chamber 331a may include a first fin 338a; the second head 330b and/or the second secondary chamber 331b may include a second fin 338b; the third head 330c and/or the third secondary chamber 331c may include a third fin 338c; and the fourth head 330d and/or the fourth secondary chamber 331d may include a fourth fin 338d. Each of the fins 338 may be configured (e.g., sized, shaped and/or dimensioned) to be coated in and/or to capture at least a portion of the fluid 180 (e.g., in liquid form) in each of the respective secondary chambers 331 during operation of the system. For example, as the energy generation device 300 rotates and a majority of the fluid 180 (e.g., in liquid form) flows back towards and/or into the primary chamber 318, the fins 338 may be configured to capture, hold, and/or retain a small amount of such fluid 180 (e.g., in liquid form) within its respective secondary chamber 331, which may effectively increase the surface area of the fluid 180 and/or promote evaporation of the fluid 180 therein. In the example, the first fin 338a may be configured (e.g., sized, shaped, and/or dimensioned) to retain a portion of the fluid 180 (e.g., in liquid form) in the first secondary chamber 331a; the second fin 338b may be configured (e.g., sized, shaped, and/or dimensioned) to retain a portion of the fluid 180 (e.g., in liquid form) in the second secondary chamber 331b; the third fin 338c may be configured (e.g., sized, shaped, and/or dimensioned) to retain a portion of the fluid 180 (e.g., in liquid form) in the third secondary chamber 331c; and the fourth fin 338d may be configured (e.g., sized, shaped, and/or dimensioned) to retain a portion of the fluid (e.g., in liquid form) 180 in the fourth secondary chamber 331d.

Notably, there may be embodiments which include the first surface enhancing structure 322 and not the fins 338, or which include the fins 338 and not the first surface enhancing structure 322. Further, in some embodiments, there may be additional fins, for example, multiple fins within a single head 330. Fins may also be included that are formed of different shapes than the fins 338, or which are different sizes relative to the respective heads 330 in which such fins are located.

As may be recognized by those of ordinary skill in the art based on the teachings herein, numerous changes and modifications may be made to the above-described and other embodiments of the present disclosure without departing from the scope of the disclosure. The components of the energy generation device(s) as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the energy generation device(s) may include more or fewer components or features than the embodiments as described and illustrated herein. For example, the components and features of FIGS. 1-23 may be used interchangeably and in alternative combinations as would be modified or altered by one of skill in the art. As a specific example, energy generation devices 100, 300, and 400 may be used in alternative combinations as would be modified or altered by one of skill in the art. As an additional example, the components and features of the shafts 140, 240 may be used in alternative combinations as would be modified or altered by one of skill in the art. Accordingly, this detailed description of the currently-preferred embodiments is to be taken illustratively, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A system for generating rotational force(s), the system comprising:
a body having a primary chamber; and
a plurality of extension members having a plurality of secondary chambers, wherein each extension member of the plurality of extension members includes at least one secondary chamber in fluid communication with the primary chamber.

2. The system of claim 1, wherein a first extension member of the plurality of extension members includes a first stem, and wherein the first stem facilitates fluid communication between the primary chamber and a first secondary chamber of the plurality of secondary chambers.

3. The system of claim 1, wherein an interior space defined by at least the primary chamber and the plurality of secondary chambers is vacuum sealed from an external environment outside of the body and the plurality of extension members.

4. The system of claim 1, wherein the body is a better conductor of heat than at least one secondary chamber of the plurality of secondary chambers.

5. The system of claim 1, wherein at least a portion of an exterior surface of the body includes a first material and at least a portion of one or more exterior surfaces of the plurality of extension members include a second material, wherein the first material is a better conductor of heat than the second material.

6. The system of claim 1, wherein the body is rotatably mounted on or to a shaft, and wherein the shaft is connected to a motor and an energy storage device.

7. The system of claim 6, further comprising:
a thermoelectric heat pump connected to at least the motor, wherein the thermoelectric heat pump comprises:
a heating portion and/or a cooling portion;
wherein the heating portion transfers heat to the body and/or the cooling portion transfers heat away from one or more extension member of the plurality of extension members.

8. The system of claim 1, wherein each extension member of the plurality of extension members is arranged radially and symmetrically about a center axis of the body, the center axis extending from a center of a bottom of the body through a center of a top side of the body.

9. The system of claim 1, wherein each extension member of the plurality of extension members are equally weighted with respect to each other about the body.

10. A system for generating energy, the system comprising:
a generator comprising:
a body having a primary chamber; and
a plurality of extension members connected to the body, wherein each extension member of the plurality of extension members defines at least one secondary chamber in fluid communication with the primary chamber;
wherein the generator is rotatably connected to a shaft; and
wherein the shaft is rotatably connected to a motor and is configured to transfer a rotational force of the generator to the motor.

11. The system for generating energy of claim 10, further comprising a thermoelectric heat pump powered by the motor.

12. The system of claim 11, wherein the thermoelectric heat pump includes a heating portion that transfers heat to the body.

13. The system of claim 11, wherein the thermoelectric heat pump includes a cooling portion that transfers heat away from at least one extension member of the plurality of extension members.

14. The system of claim 10, wherein at least the primary chamber includes a liquid, and wherein the body is tilted with respect to a direction of gravity such that a first opening of a first stem of a first extension member of the plurality of extension members is submerged within the liquid, and wherein a second opening of a second stem of a second extension member of the plurality of extension members is located at least partially outside of the liquid.

15. A method of generating electricity comprising:
creating a pressure differential between a primary chamber of a body of a generator containing a liquid and at least one secondary chamber of an extension member of the generator, wherein the at least one secondary chamber is in fluid communication with the primary chamber;
at least partially rotating the generator about a center axis extending from a center of a top of the body through a center of the bottom of the body, the at least partially rotating caused by the creating a pressure differential; and
transferring a force of a rotational movement of the generator to a motor and/or an energy storage device.

16. The method of claim 15, wherein the creating a pressure differential further comprises heating the primary chamber and/or cooling the at least one secondary chamber, wherein the liquid forms a barrier preventing the exchange of gas and/or vapor between the primary chamber and the at least one secondary chamber.

17. The method of claim 15, wherein the transferring the force of the rotational movement further comprises transferring the force of the rotational movement caused by the at least partially rotating the generator through a shaft connected to the generator.

18. The method of claim 15, wherein the method further comprises:
powering a thermoelectric heat pump using at least a portion of the rotational force; and
transferring heat from a heating portion of the thermoelectric heat pump to the body.

19. The method of claim 15, wherein the method further comprises:
powering a thermoelectric heat pump using at least a portion of the rotational force; and
transferring heat from the at least the extension member to a cooling portion of the thermoelectric heat pump.

20. The method of claim 15, wherein the extension member is a first extension member of a plurality of extension members, and wherein the plurality of extension members includes a plurality of stems having a plurality of primary openings in the primary chamber of the body;
wherein a bottom of the body of the generator is angled such that at least a first primary opening of a first stem of the first extension member is fully submerged within the liquid in the primary chamber, and wherein at least a second primary opening of the plurality of primary openings is at least partially outside of the liquid in the primary chamber; and
wherein the at least partially rotating the generator further comprises:
partially rotating the generator such that the second primary opening is fully submerged within the liquid in the primary chamber and the first primary opening is at least partially outside of the liquid in the primary chamber.
